(19) United States
(12) Patent Application Publication
(10) Pub. No.: US 2008/0297983 A1
(43) Pub. Date: Dec. 4, 2008

(54) Electrode Sheet For Capacitors, Method For Manufacturing The Same, And Electrolytic Capacitor

(75) Inventors: Hiroyuki Kawabata, Tochigi (JP); Atsushi Otaki, Tochigi (JP); Tomoaki Yamanoi, Tochigi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K., MINATO-KU, TOKYO (JP)

(21) Appl. No.: 10/594,246

(22) PCT Filed: Mar. 24, 2005
(86) PCT No.: PCT/JP2005/006233

§ 371 Date: Aug. 21, 2008

Related U.S. Application Data
(60) Provisional application No. 60/556,892, filed on Mar. 29, 2004.

(30) Foreign Application Priority Data
Mar. 24, 2004 (JP) 2004-86467

(51) Int. Cl. C25D 7/06; C23C 4/08; H01G 9/025; H01G 9/045

(52) U.S. Cl. 361/529; 427/456; 205/153; 361/523

(57) ABSTRACT

A method for manufacturing an electrode sheet for capacitors includes the step of thermally spraying mixed powder 6 in which intermetallic compound powder of Al and valve action metal other than Al, such as Ti, Zr, Nb, Ta and Hf, and Al powder are mixed, onto a surface of an aluminum foil 2, or supplying intermetallic compound powder 7 of Al and valve action metal other than Al, such as Ti, Zr, Nb, Ta and Hf, and Al powder 8 from different positions and thermally spraying the intermetallic compound powder and the Al powder onto a surface of an aluminum foil 2, to thereby form an Al-valve action metal alloy layer on at least one surface of the aluminum foil 2.

This application claims priority to Japanese Patent Application No. 2004-86467 filed on Mar. 24, 2004 and U.S. Provisional Application No. 60/556,892 filed on Mar. 29, 2004, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application No. 60/556,892 filed on Mar. 29, 2004, pursuant to 35 U.S.C. §111(b).

### TECHNICAL FIELD

The present invention relates to an electrode sheet for capacitors excellent in bending durability, which is capable of attaining large capacitance, a method for manufacturing the electrode sheet, and an electrolytic capacitor.

In this disclosure including claims, the wording of “aluminum” is used to include the meaning of its alloy. Furthermore, in this disclosure, the wording of “Al” denotes aluminum (metal simple substance).

### BACKGROUND ART

The following description sets forth the inventor's knowledge of related art and problems therein and should not be construed as an admission of knowledge in the prior art.

In accordance with the recent digitalization of electric equipments, electrolytic capacitors have been demanded to be small in size and large in capacitance. Among other things, in communication facilities such as personal computers and cellular phones, in accordance with the increased operation speed of CPUs to be mounted therein, it has been strongly demanded to further increase capacitance of capacitors.

As an electrode foil for capacitors capable of securing large capacitance, an electrode foil manufactured by forming an alloy foil of valve action metal (valve metal) such as Ti and Zr and aluminum by a liquid quenching method, etching this alloy foil, and then anodizing the alloy foil to form an oxide film on the surface thereof is known (see Japanese Unexamined Laid-open Patent Publication No. S60-66806, hereinafter referred to as “Patent Document 1). Since the dielectric constant of the oxide film of the alloy foil comprising such valve action metal and aluminum is extremely large, large capacitance can be secured.

However, an aluminum alloy foil obtained by such a liquid quenching method was insufficient in strength, especially low in bending strength and therefore poor in bending durability. In recent years, in most electrolytic capacitors, a structure in which electrode foils are wound is employed in view of the demand of miniaturization. However, in the aforementioned conventional aluminum alloy foil (obtained by a liquid quenching method), since the foil is easily broken when it is wound, it cannot be put into practical use at all. Under the circumstances, as an electrode material for electrolytic capacitors, it has been proposed to use an electrode foil manufactured by plasma-spraying powder of aluminum alloy (e.g., Al—Zr alloy, Al—Ti alloy) containing valve action metal such as Zr or Ti, or mixed power of Al power and valve action metal powder (e.g., Zr powder, Ti powder) onto a surface of an aluminum foil, then subjecting the aluminum foil to sintering or rolling in inert atmosphere to thereby form a porous coating layer on the surface of the aluminum foil (see Japanese Unexamined Laid-open Patent Publication No. H2-91918, hereinafter referred to as “Patent Document 2,” a especially see claims and page 4, left lower column to right upper column of the specification). The electrode foil can attain large capacitance and high bending strength, thus excellent bending durability. Accordingly, it can be applied to wound type electrolytic capacitors.

However, in cases where the Al-valve action metal alloy powder is used as the thermal spraying material among the manufacture methods described in the aforementioned Patent Documents 2, in order to produce the alloy powder, casting for quality governing and then atomizing for disintegration should be executed. In other words, the Al-valve action metal alloy with high-melting point should be molten twice. This increases the manufacturing cost and deteriorates the productivity. Please note that the Al-valve action metal alloy powder can be industrially manufactured only by the aforementioned atomizing method since it is difficult to obtain power by grinding the Al-valve action metal alloy.

On the other hand, in cases where the mixed powder of Al-powder and Al-valve action metal alloy powder is used as thermal spraying materials among the manufacture methods described in the aforementioned Patent Documents 2, though powder of the latter valve action metal can be industrially manufactured only by the atomizing method as mentioned above, it is not easy to manufacture valve-action metal powder by the atomizing method because of the high fusing point. This increases the manufacturing cost and deteriorates the productivity. Furthermore, in cases where mixed powder comprising Al powder and valve action metal powder are thermally sprayed, the thermally sprayed alloy will be diploidized (multilayered).

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

Other objects and advantages of the present invention will be apparent from the following preferred embodiments.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

The present invention was made in view of the aforementioned problems. Among other potential advantages, some embodiments can provide an electrode sheet for capacitors excellent in bending durability and capable of attaining large capacitance, a method for manufacturing the electrode sheet efficiently at low cost, and an electrolytic capacitor small in size but large in capacity.

To attain the aforementioned objects, the present invention provides the following structure.

[1] A method for manufacturing an electrode sheet for capacitors, the method comprising the step of:

thermally spraying mixed powder in which intermetallic compound powder comprising of Al and valve action metal other than Al and Al powder are mixed, onto a surface of an aluminum foil to thereby form an alloy layer of Al-valve action metal other than Al on at least one surface of the aluminum foil.

[2] A method for manufacturing an electrode sheet for capacitors, the method comprising the steps of:

supplying Al powder and intermetallic compound powder comprising of Al and valve action metal other than Al from different positions; and

thermally spraying both powders of the intermetallic compound and the Al onto a surface of an aluminum foil to thereby form an Al-valve action metal alloy layer on at least one surface of the aluminum foil.

[3] The method for manufacturing an electrode sheet for capacitors as recited in the aforementioned Item 1 or 2, wherein the thermal splaying is performed by plasma spraying.

[4] A method for manufacturing an electrode sheet for capacitors, the method comprising the step of:

supplying Al powder and intermetallic compound powder comprising of Al and valve action metal other than Al from different positions into a single plasma flow; and

thermally spraying the plasma flow onto a surface of an aluminum foil to thereby form an alloy layer of Al-valve action metal other than Al on at least one surface of the aluminum foil.

[5] The method for manufacturing an electrode sheet for capacitors as recited in any one of the aforementioned Items 1 to 4, further comprising the step of rolling the electrode sheet after forming an alloy layer of the Al-valve action metal other than Al.

[6] The method for manufacturing an electrode sheet for capacitors as recited in any one of the aforementioned Items 1 to 5, further comprising the step of annealing the electrode sheet after forming an alloy layer of the Al-valve action metal other than Al.

[7] The method for manufacturing an electrode sheet for capacitors as recited in any one of the aforementioned Items 1 to 6, wherein an average particle diameter of the intermetallic compound powder is 3 to 100 μm, and wherein an average particle diameter of the Al powder is 3 to 150 μm.

[8] The method for manufacturing an electrode sheet for capacitors as recited in any one of the aforementioned Items 1 to 7, wherein a thermal spraying mass ratio of the intermetallic compound powder and the Al powder (intermetallic compound powder/Al powder) is set so as to fall within the range of 0.1 to 5.

[9] The method for manufacturing an electrode sheet for capacitors as recited in any one of the aforementioned Items 1 to 8, wherein powder of intermetallic compounds comprising of Al and one or more elements selected from the group consisting of Ti, Zr, Nb, Ta and Hf is used as the intermetallic compound powder.

[10] The method for manufacturing an electrode sheet for capacitors as recited in any one of the aforementioned Items 1 to 8, wherein Al₃Zr powder is used as the intermetallic compound powder.

[11] The method for manufacturing an electrode sheet for capacitors as recited in any one of the aforementioned Items 1 to 10, wherein an alloy foil comprising of Al and valve action metal comprising one or more elements selected from the group consisting of Ti, Zr, Nb, Ta and Hf is used as the aluminum foil.

[12] A capacitor electrode sheet manufactured by the method as recited in any one of the aforementioned Items 1 to 11, wherein a fine structure of the Al-valve action metal alloy layer comprises an intermetallic compound phase and an Al simple substance phase, and wherein an interval of adjacent secondary branches in a dendrite (dendrite crystal) of the intermetallic compound phase is 5 μm or less.

[13] A capacitor electrode sheet in which an aluminum alloy coating layer is integrally formed on at least one surface of a core material made of aluminum foil,

wherein a fine structure of the coating layer comprises an intermetallic compound phase and an Al simple substance phase.

[14] The capacitor electrode sheet as recited in the aforementioned Item 13, wherein an interval of adjacent secondary branches in a dendrite (dendrite crystal) of the intermetallic compound phase is 5 μm or less.

[15] The capacitor electrode sheet as recited in the aforementioned Item 13 or 14, wherein a thickness of the core material is 5 to 200 μm, and wherein the thickness of the coating layer is 5 to 150 μm.

[16] A method for manufacturing an anode material for electrolytic capacitors, the method comprising the steps of:

etching the electrode sheet manufactured by the method as recited in any one of the aforementioned Items 1 to 11; and then

subjecting the etched electrode sheet to an anodizing treatment to form a dielectric skin on the surface of the electrode sheet.

[17] An anode material for electrolytic capacitors manufactured by the method as recited in the aforementioned Item 16.

[18] An electrolytic capacitor constituted by using the anode material as recited in the aforementioned Item 17.

[19] A method for manufacturing an anode material for electrolytic capacitors, the method comprising the steps of:

etching the electrode sheet as recited in the aforementioned Item 12; and then

subjecting the etched electrode sheet to an anodizing treatment to form a dielectric skin on the surface of the electrode sheet.

[20] An anode material for electrolytic capacitors manufactured by the method as recited in the aforementioned Item 19.

[21] An electrolytic capacitor constituted by using the anode material as recited in the aforementioned Item 20.

[22] A method for manufacturing an anode material for electrolytic capacitors, the method comprising the steps of:

etching the electrode sheet as recited in any one of the aforementioned Items 13 to 15; and then

subjecting the etched electrode sheet to an anodizing treatment to form a dielectric skin on the surface of the electrode sheet.

[23] An anode material for electrolytic capacitors manufactured by the method as recited in the aforementioned Item 22.

[24] An electrolytic capacitor constituted by using the anode material as recited in the aforementioned Item 23.

In the invention as recited in the aforementioned Item [1] and [2], since the intermetallic compound and the Al are compounded at the time of thermal spraying, an electrode sheet in which an alloy layer comprising of Al and value action metal other than Al (denoted as “Al-value action metal alloy” on the specification) is formed on the surface of the aluminum foil can be manufactured. Since the dielectric constant of the oxide film of the aforementioned Al-valve action metal alloy is extremely large, large capacitance can be secured. Moreover, since the Al-valve action metal alloy layer is formed by thermal spraying, the obtained electrode sheet is excellent in bending durability. Furthermore, in the aforementioned manufacturing method, the intermetallic compound powder comprising Al and valve action metal other than Al and Al powder are used as the thermal spraying materials. In this case, since the intermetallic compound powder can be easily obtained by a known grinding method, and Al powder is low in melting point and can be obtained at low cost, the electrode sheet for capacitors can be efficiently manufactured at low cost.

In the invention as recited in the aforementioned Item [2], a step of mixing intermetallic compound powder and Al powder to obtain mixed powder can be omitted, which further can improve the productive efficiency.

In the invention as recited in the aforementioned Item [3], since thermal spraying is carried out using plasma spraying, a cooling rate can be remarkably increased, resulting in fine structure in the Al-valve action metal alloy layer, which in turn can further improve the bending durability of the electrode sheet.

In the invention as recited in the aforementioned Item [4], since the intermetallic compound and the Al are alloyed at the time of thermal spraying, an electrode sheet in which the Al-valve action metal alloy layer is formed on the surface of aluminum foil can be manufactured. Since the dielectric constant of the oxide film of the aforementioned Al-valve action metal alloy is extremely large, large capacitance can be secured. Moreover, since the Al-valve action metal alloy layer is formed by plasma thermal spraying, the cooling rate can be markedly increased, resulting in fine structure in the Al-valve action metal alloy layer, which in turn can further improve the bending durability of the electrode sheet. Furthermore, in this manufacturing method, the intermetallic compound powder of valve action metal and Al and Al powder are used as the thermal spraying materials. In this case, since the intermetallic compound powder can be easily obtained by a known grinding method, and Al powder is low in melting point and can be obtained at low cost, the electrode sheet for capacitors ban be efficiently manufactured at low cost. In addition, since a step of mixing intermetallic compound powder and Al powder to obtain mixed powder can be omitted, the productive efficiency can be further improved.

In the invention as recited in the aforementioned Item [5], since the sheet is rolled after forming the alloy layer of an Al-valve action metal, the unevenness of the surface of the alloy layer is flattened. Therefore, the surface flatness of the sheet can be improved and the thickness of the electrode sheet can be equalized.

In the invention as recited in the aforementioned Item [6], since annealing is carried out after forming the Al-valve action metal alloy layer, the bending durability of the electrode sheet can be further improved, and the rolling load can be decreased when it is rolled.

In the invention as recited in the aforementioned Item [7], the thermal spraying of the powder can be performed in a stable manner, and generation of voids in the Al-valve action metal alloy layer can be prevented effectively.

In the invention as recited in the aforementioned Item [8], the capacitance of the obtained electrode sheet can be further improved. If the thermal spraying amount of the intermetallic compound powder exceeds the upper limit of the preferable range of the above-mentioned thermal spraying mass ratio, it is not preferable since the rate of an abundance ratio of the intermetallic compound phase in the Al-valve action metal alloy layer (thermally sprayed layer) becomes too large, and the size of the etching pit formed by the etching treatment becomes small, and therefore the electrolyte would not enter into all of the etching layers. On the other hand, if the thermal spraying amount of the Al powder exceeds the maximum of the preferable range of the aforementioned thermal spraying mass ratio, it is not preferable since the rate of an abundance ratio of the intermetallic compound phase in the Al-valve action metal alloy layer (thermally sprayed layer) becomes too small, and therefore sufficient capacitance cannot be obtained.

In the invention as recited in the aforementioned Item [9], an electrode sheet with larger capacitance can be manufactured.

In the invention as recited in the aforementioned Item [10], an electrode sheet with larger capacitance can be manufactured.

In the invention as recited in the aforementioned Item [11], since an Al foil or the aforementioned specific aluminum alloy foil is used as the aluminum foil of the core material, skin defects would be hardly generated at the time of chemical conversion treatment (anodizing treatment), and leakage current can be decreased.

In the invention as recited in the aforementioned Item [12], since the electrode sheet for capacitors is excellent in productive efficiency, the manufacturing cost can be reduced, sufficient capacitance can be secured and it is excellent in bending durability. Moreover, since the interval of the adjacent secondary branches in the dendrite of the intermetallic compound phase is 5 μm or less, larger capacitance can be secured.

In the electrode sheet for capacitors according to the invention as recited in the aforementioned Item [13], since the dielectric constant of the oxide film of the aluminum alloy made of the valve action metal and Al is extremely large, large capacitance can be secured. Moreover, since the fine structure of the coating layer comprises a phase of the intermetallic compound comprising of valve action metal such as Ti, Zr, Nb, Ta and Hf, and Al, and a simple substance phase of Al, it is excellent in bending durability.

In the invention as recited in the aforementioned Item [14], since the interval of the adjacent secondary branches in the dendrite of the intermetallic compound phase is 5 μm or less, larger capacitance can be secured.

In the invention as recited in the aforementioned Item [15], since the thickness of the core material and that of the coating layer are specified within the aforementioned specific range, respectively, while securing lightweight, enough sheet strength and large capacitance can be secured.

In the invention as recited in the aforementioned Item [16], since the surface area of the coating layer can be increased by etching and a dielectric skin with a large dielectric constant can be formed by a chemical conversion treatment, it becomes possible to provide an electrolytic capacitor further improved in capacity.

In the anode material according to the invention as recited in the aforementioned Item [17], since large capacitance and excellent bending durability can be secured, this anode material enables us to provide a rolled type electrolytic capacitor small in size and large in capacity.

In the invention as recited in the aforementioned Item [18], since it is constituted by using the anode material as recited in the aforementioned Item [17], an electrolytic capacitor small in size and large in capacitance can be provided. Moreover, since the anode material as recited in the aforementioned Item [17] is excellent in bending durability, it also makes it possible to provide a rolled type electrolytic capacitor small in size and large in capacity.

In the invention as recited in the aforementioned Item [19], since the surface area of the coating layer can be increased by etching and a dielectric skin with a large dielectric constant can be formed by a chemical conversion treatment (anodizing treatment), it is possible to provide an electrolytic capacitor with further improved capacity.

In the anode material according to the invention as recited in the aforementioned Item [20], since large capacitance and excellent bending durability can be secured, this anode material enables us to provide a rolled type electrolytic capacitor small in size and large in capacity.

In the invention as recited in the aforementioned Item [21], since it is constituted by using the anode material as recited in the aforementioned Item [20], an electrolytic capacitor small in size and large in capacitance can be provided. Moreover, since the anode material as recited in the aforementioned Item [20] is excellent in bending durability, it also makes it possible to provide a rolled type electrolytic capacitor small in size and large in capacity.

In the invention as recited in the aforementioned Item [22], since the surface area of the coating layer can be increased by etching and a dielectric skin with a large dielectric constant can be formed by a chemical conversion treatment (anodizing treatment), it becomes possible to provide an electrolytic capacitor furthermore improved in capacity.

In the anode material according to the invention as recited in the aforementioned Item [23], since large capacitance and excellent bending durability can be secured, this anode material enables us to provide a rolled type electrolytic capacitor small in size and large in capacity.

In the invention as recited in the aforementioned Item [24], since it is constituted by using the anode material as recited in the aforementioned Item [23], an electrolytic capacitor small in size and large in capacitance can be provided. Moreover, since the anode material as recited in the aforementioned Item [23] is excellent in bending durability, it also makes it possible to provide a rolled type electrolytic capacitor small in size and large in capacity.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWINGS

FIG. 1A is a schematic view showing one example of a thermal spraying method for thermally spraying intermetallic compound powder and Al powder, FIG. 1B is a schematic view showing another example, and FIG. 1C is a schematic view showing still another example.

FIG. 2 is a cross-sectional view showing an electrode sheet according to the first embodiment of this invention.

FIG. 3 is a scanning-electron-microscope (SEM) photograph showing a cross-section of a thermally sprayed layer (alloy layer of Al-valve action metal) of the electrode sheet shown in FIG. 2.

FIG. 4 is an enlarged SEM photograph showing a part of the photograph shown in FIG. 3.

FIG. 5 is a schematic illustration showing the fine structure of the thermally sprayed layer (alloy layer of the Al-valve action metal) of the electrode sheet of this invention.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

In a method for manufacturing an electrode sheet for capacitors according to a preferable embodiment of the present invention, powder 8 of Al and powder 7 of intermetallic compound comprising of valve action metal other than Al, such as Ti, Zr, Nb, Ta and Hf, and Al are thermally sprayed onto a surface of an aluminum foil 2 to thereby form an Al-valve action metal alloy layer 11 on at least one surface of the aluminum foil 2. The value action metal other than Al (the value action metal except Al) is preferably used at least one selected from the group consisting of Ti, Zr, Nb, Ta and Hf.

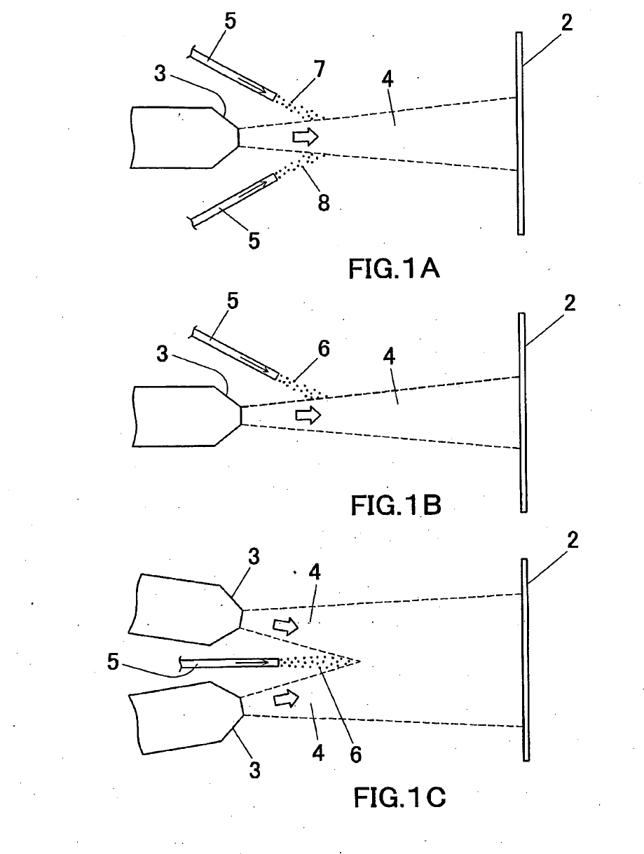

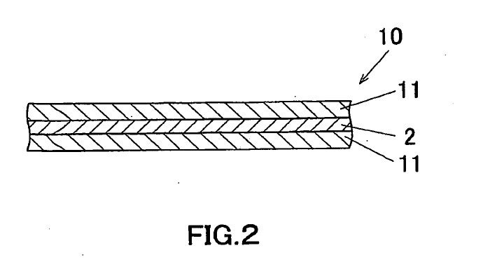

According to this manufacturing method, since the intermetallic compound and Al are alloyed at the time of the thermal spraying, an electrode sheet 10 in which an alloy layer 11 of Al-valve action metal is laminated (formed) on each surface of an aluminum foil 2 can be manufactured. For example, as shown in FIG. 2, if the powder is thermally sprayed on both surfaces of the aforementioned aluminum foil 2, an electrode sheet 10 in which an alloy layer 11 of Al-valve action metal is laminated on each surface of a core material 2 of an aluminum foil can be obtained. The dielectric constant of the oxide film of the aforementioned Al-valve action metal alloy is extremely large, and therefore an electrode sheet 10 capable of attaining large capacitance can be obtained. Furthermore, the thermal spaying causes an Al-valve action metal alloy layer, and therefore the obtained electrode sheet 10 is also excellent in bending durability. Furthermore, in this manufacturing method, as thermally spraying materials, intermetallic compound powder 7 of valve action metal and Al and Al powder 8 are used. The intermetallic compound powder 7 can be easily obtained by powdering the compound with a grinding method, and the Al powder 8 is low in melting point and can be obtained at low cost. Therefore, an electrode sheet 10 for capacitors can be manufactured efficiently at lower cost. As shown in FIG. 1A, for example, the thermal spraying can be performed by supplying compound powder 7 of valve action metal and Al and Al powder 8 from different positions to thereby thermally spraying both the powders onto a surface of an aluminum foil 2. Alternatively, as shown in FIGS. 1B and C, mixed powder 6 in which compound powder 7 of valve action metal and Al and Al powder 8 are mixed can be thermally sprayed onto a surface of an aluminum foil 2.

In detail, in the case of FIG. 1A, while emitting a plasma flow 4 via a nozzle 3, intermetallic compound powder 7 comprising of valve action metal other than Al and Al is thrown in the plasma flow 4 from one of the pair of feeding pipes 5 arranged at both sides of the nozzle 3 and Al powder 8 is also thrown into the plasma flow 4 from the other pipe 5 to thereby thermally spray the plasma flow 4 onto the surface of the aluminum foil 2.

In the case shown in FIG. 1B, while emitting a plasma flow 4 via a nozzle 3, mixed powder 6 in which intermetallic compound powder 7 of valve action metal and Al and Al powder are mixed is thrown in the plasma flow 4 from a feeding pipe 5 arranged beside the nozzle 3 to thereby thermally spray the plasma flow 4 onto the surface of the aluminum foil 2.

Furthermore, in the case shown in FIG. 1C, while emitting plasma flows 4 and 4 from a pair of nozzles 3 and 3 to form a joined plasma flow, mixed powder 6 in which intermetallic compound powder 7 of valve action metal and Al and Al powder are mixed is thrown in the joined plasma flow 4 from a feeding pipe 5 arranged between the pair of nozzles 3 to thereby thermally spray the plasma flow 4 onto the surface of the aluminum foil 2.

As the thermal spraying method mentioned above, any well-known thermal spraying method can be employed, and a plasma thermal spraying method and a cold spraying method can be exemplified, but not limited thereto. Among other things, it is preferable to perform the thermal spraying by a plasma spray coating method. In this case, the cooling rate can be markedly increased, causing organization of the Al-valve action metal alloy layer 11 to be sufficiently minute, which in turn can improve the bending durability of the electrode sheet 10.

When gas, such as argon gas and helium gas, is introduced into a space between electrodes and the electrodes are discharged therebetween, ionized high temperature and high speed plasma will be generated. The aforementioned plasma spray coating method is a method using such plasma as a heat source. In this method, spraying material powder is supplied in a high temperature and high speed plasma flow (plasma jet), causing the powder to be heated and accelerated, and whereby the heated and accelerated powder is collided against a substrate.

In the aforementioned cold spray, high-pressure gas heated to a temperature lower than the melting point or softening temperature of the thermally spraying material is made into a supersonic flow, and thermally spraying material powder is supplied in the supersonic flow, whereby the powder is collided against a substrate in the solid phase state.

Changing the setting of thermal spraying conditions (e.g., changing the thermal spraying temperature and/or the gas mass flow) enables the formation of a porous or nonporous alloy layer 11 of the aforementioned Al-valve action metal.

In the manufacturing method of this invention, annealing can be performed after the step for forming the Al-valve action metal alloy layer 11 on the aluminum foil 2. Such annealing further improves the bending durability of the electrode sheet and reduces the load for rolling the sheet.

In the manufacturing method of this invention, a rolling step can be performed after the step for forming the Al-valve action metal alloy layer 11 on the aluminum foil 2. This rolling step enables an improvement of the flatness of the surface of the Al-valve action metal alloy layer 11 by eliminating the irregularity of the surface and equalization of the thickness of an electrode sheet 10 (the thickness variation different in place can be eliminated).

Furthermore, an annealing step can be performed between the lamination (layer forming) step and the rolling step, or an annealing step can be performed after the rolling step, or after the lamination step an annealing step can be performed after and before the rolling step.

The average particle diameter of the intermetallic compound powder 7 used for the thermal spraying preferable falls within the range of from 3 to 100 μm. If it is less than 3 μm, it is not preferable since the supply nozzles, such as a material feeding pipe 5, tends to be clogged easily. On the other hand, if it exceeds 100 μm, it is not preferable since voids tend to be generated in a thermally sprayed layer 11, i.e., the Al-valve action metal alloy layer. It is especially preferable that the average particle diameter of the intermetallic compound powder 7 falls within the range of from 5 to 50 μm.

The average particle diameter of the Al powder 8 used for the thermal spraying preferably falls within the range of from 3 to 150 μm. If it is less than 3 μm, it is not preferable since the supplying nozzle, such as a material feeding pipe 5, tends to be clogged. On the other hand, if it exceeds 150 μm, it is not preferable since voids tend to be easily generated in the thermally sprayed layer 11, i.e., the Al-valve action metal alloy later. It is especially preferable to set such that the average particle diameter of the Al powder 8 falls within the range of from 5 to 70 μm.

It is preferable to set that the thermal spraying mass ratio of the intermetallic compound powder 7 and the Al powder 8 (i.e., intermetallic compound powder/Al powder) falls within the range of from 0.1 to 5. If it is less than 0.1, it is not preferable since the quantity of the intermetallic compound in the thermal spraying alloy layer 11 decreases too much, the intermetallic compound is dropped off at the time of etching and therefore the desired capacitance cannot be obtained. On the other hand, if it exceeds 5, it is not preferable since the quantity of the intermetallic compound in a thermal spraying alloy layer 11 increases too much, resulting in too small in etching pit to be formed by the etching processing, which inhibits entering of all of electrolyte into the etching layers, and therefore the desired capacitance cannot be obtained. It is especially preferable to set such that the thermal spraying mass ratio of the intermetallic compound powder 7 and the Al powder 8 falls within the range of from 0.5 to 2.

In the manufacturing method of this invention, as the aforementioned intermetallic compound powder 7, it is preferable to use intermetallic compound powder comprising Al and one or more action metals selected from the group consisting of Ti, Zr, Nb, Ta and Hf. In this case, it is possible to manufacture an electrode sheet 10 capable of attaining larger capacitance. Among other things, it is especially preferable to use Al₃Zr powder as the aforementioned intermetallic compound powder 7.

Furthermore, as the aforementioned aluminum foil 2, it is preferable to use an Al foil or an alloy foil comprising Al and one or more valve action metals selected from the group consisting of Ti, Zr, Nb, Ta and Hf. In this case, film defects which may be generated when subjecting the obtained electrode sheet to a chemical conversion treatment (anodizing treatment) can be decreased, resulting in smaller leakage current.

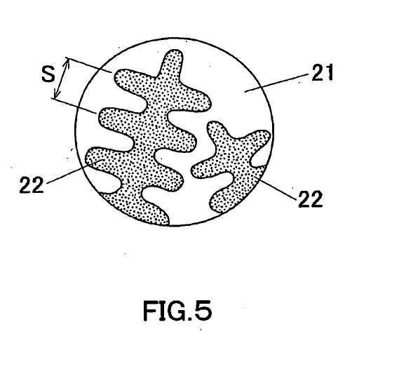

In the electrode sheet for capacitors 10 manufactured by the manufacturing method of this invention, the fine structure of the Al-valve action metal alloy layer 11 comprises an intermetallic compound phase 22 and a simple substance phase 21 of Al, and the interval S of the adjacent secondary branches in the dendrite (dendrite crystal) of the aforementioned intermetallic compound phase 22 is 5 μm or less (see FIG. 5). Since the interval S of the adjacent secondary branches in the dendrite of the aforementioned intermetallic compound phase 22 is 5 μm or less, the exposed surface area of the intermetallic compound phase becomes larger after the etching treatment, which secures sufficient capacitance. Smaller interval S of the secondary branch can be attained by increasing the solidification speed by increasing the thermal spraying temperature.

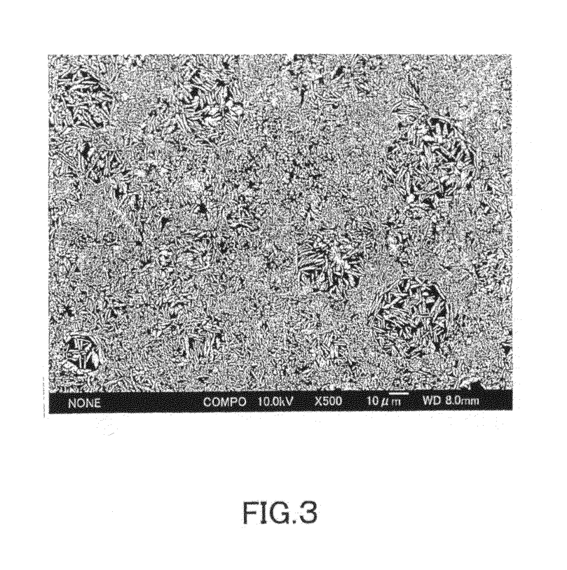

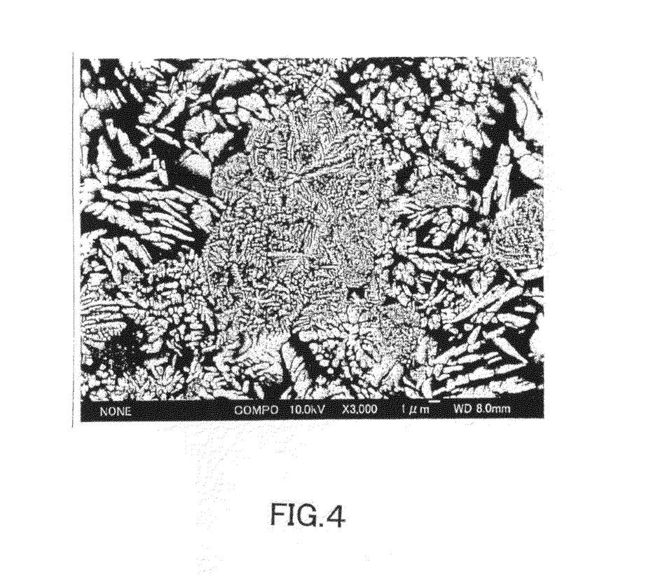

A scanning electron microscope (SEM) photograph showing a section of an Al-valve action metal alloy layer 11 according to an embodiment of an electrode sheet for capacitors 10 manufactured in accordance with the manufacturing method of this invention is shown in FIG. 3. In FIG. 3, the white region shows an intermetallic compound phase and the black region shows an Al simple substance phase. FIG. 4 shows a partially enlarged view of the SEM photograph shown in FIG. 3, and the white region shows an intermetallic compound phase and the black region shows an Al simple substance phase. It is recognized that in the central portion of FIG. 4 a dendrite (dendrite crystal) of an intermetallic compound phase is formed.

The aforementioned “interval of adjacent secondary branches in a dendrite” denotes a central distance S between adjacent secondary branches (secondary arms) in a dendrite, namely, a distance S from a central axis of one of adjacent secondary branches from that of another, as shown in FIG. 5. It is also called “dendrite arm spacing.”

The electrode sheet 10 for capacitors according to this invention includes a core material 2 of an aluminum foil and an aluminum alloy coating layer 11 formed on at least one surface of the core material 2, and is characterized in that the fine structure of the coating layer 11 is comprised of an intermetallic compound phase comprising Al and valve action metal other than Al, such as Ti, Zr, Nb, Ta and Hf, and an Al simple substance phase. The aforementioned coating layer 11 can be either porous or non-porous in structure.

In the electrode sheet 10 for capacitors of this invention, the interval S of the adjacent secondary branches in the dendrite (dendrite crystal) of the intermetallic compound phase 22 is preferably 5 μm or less. If it exceeds 5 μm, it is not preferable since the exposed surface area of the intermetallic compound phase becomes smaller after the etching treatment, resulting in insufficient capacitance. It is more preferable that the interval S of the adjacent secondary branches is 0.5 μm or less.

In the electrode sheet 10 of this invention, it is preferable that the thickness of the core material 2 of an aluminum foil is 5 to 200 μm. If it is less than 5 μm, it is not preferable since the rigidity as an electrode sheet 10 becomes inadequate, which may easily cause cracks when the electrode sheet 10 is bent or cut. On the other hand, if it exceeds 200 μm, it is not preferable since the curvature radius R of the electrode sheet 10 becomes larger when it is rolled so as to be stored in a casing, which makes it difficult to store the rolled sheet in a casing. It is more preferable that the thickness of the core material 2 of the aluminum foil is 20 to 100 μm.

It is preferable that the thickness of the coating layer 11 is 5 to 150 μm. If it is less than 5 μm, it is not preferable since the core material 2 will be exposed at the time of the etching treatment, resulting in insufficient capacitance. On the other hand, if it exceeds 150 μm, it is not preferable since electrolyte would not enter an etched layer, resulting in insufficient capacitance. It is more preferable that the thickness of the coating layer 11 is 20 to 100 μm.

A sheet suitably used as anode material for electrolytic capacitors can be manufactured by etching an electrode sheet 10 according to this invention or an electrode sheet 10 manufactured by the manufacturing method of this invention, and then subjecting it to a chemical conversion treatment to thereby form a dielectric skin electrochemically.

As the aforementioned etching treatment, a method for etching the sheet in a chloride solution or an aluminum sulfate solution while applying direct current thereto can be exemplified, though the etching treatment is not limited thereto.

As for the aforementioned chemical conversion treatment, although it is not limited to a specific one, chemical conversion treatment to be performed in a boric acid bath, a phosphoric acid bath or an adipic acid bath can be exemplified.

An electrolytic capacitor according to the present invention is constituted by the aforementioned anode material. Since the electrolytic capacitor is constituted by using the anode material including an electrode sheet 10 for capacitors according to the present invention as a constituent element is used, an electrolytic capacitor small in size but large in capacity can be obtained.

Next, concrete examples of the present invention will be explained.

### EXAMPLE 1

As shown in FIG. 1B, while emitting a plasma flow 4 from a nozzle 3, mixed powder 6 which is a mixture of Al₃Zr powder (intermetallic compound powder) with an average particle diameter of 3 μm and Al powder with an average particle diameter of 3 μm was fed from the material feeding pipe 5 arranged beside the nozzle 3, so that the plasma flow 4 was thermally sprayed onto both surfaces of a core material 2 made of an aluminum foil with a thickness of 40 μm. Thus, an electrode sheet 10 as shown in FIG. 2 was obtained. The powder mixture ratio (thermal spraying mass ratio) in the mixed powder 6, i.e., Al₃Zr powder/Al powder, was set to 1.0. The thickness of the formed thermally sprayed coating layer 11 was 60 μm. Accordingly, an electrode sheet 10 with a thickness of 160 μm was obtained.

The interval (dendrite arm spacing) of the adjacent secondary branches in the dendrite of the intermetallic compound phase in the thermally sprayed coating layer 11 of the obtained electrode sheet was 1 μm on average.

Next, the electrode sheet was immersed in a 3% (mass %) H₃PO₄ solution and boiled for 120 seconds at 90° C. Thereafter, the sheet was washed with running water and further subjected to ultrasonic cleaning in an acetone solvent, then dried for 5 minutes at 50° C.

Subsequently, etching treatment was performed. This etching treatment was performed using HCl (1 mol/L)+H₂SO₄ (3.5 mol/L) solution under the condition that the temperature of the solution was 75° C. and the current density DC was 0.5 A/cm² (one side).

Furthermore, the electrode sheet was subjected to a constant-voltage chemical conversion treatment of 20V×10 minutes and current density of 5 mA/cm² an ammonium phosphate solution (concentration: 1.5 g/L, 85° C.).

Subsequently, heat treatment (annealing) was performed for 5 minutes at 500° C. in air, and then a chemical conversion treatment was performed again under the same condition of the previous chemical conversion treatment (except that the constant-voltage chemical conversion treatment time was 5 minutes).

### EXAMPLES 2 TO 25

### COMPARATIVE EXAMPLES 1 TO 16

In each example, an electrode sheet was obtained in the same manner as in Example 1, except that Al₃Zr powder with an average particle diameter as shown in Tables 1 and 2 was used and Al powder with an average particle diameter as shown in Tables 1 and 2 was used.

TABLE 1

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite | | |
| | compound | Al powder | (intermetallic | material | layer | arm spacing | CV product | |
| | (μm) | (μm) | compound/Al) | (μm) | (μm) | (μm) | (μFV/cm²) | Evaluation |
| Comp. Ex. 1 | 1 | 20 | 1.0 | 40 | 60 | 1 | — | Nozzle clogged |
| Comp. Ex. 2 | 1 | 70 | 1.0 | 40 | 60 | 1 | — | Nozzle clogged |
| Comp. Ex. 3 | 1 | 150 | 1.0 | 40 | 60 | 1 | — | Nozzle clogged |
| Comp. Ex. 4 | 3 | 1 | 1.0 | 40 | 60 | 1 | — | Nozzle clogged |
| Example 1 | 3 | 3 | 1.0 | 40 | 60 | 1 | 2861 | ◯ |
| Example 2 | 3 | 5 | 1.0 | 40 | 60 | 1 | 2659 | ◯ |
| Example 3 | 3 | 20 | 1.0 | 40 | 60 | 1 | 2719 | ◯ |
| Example 4 | 3 | 70 | 1.0 | 40 | 60 | 1 | 2836 | ◯ |
| Example 5 | 3 | 150 | 1.0 | 40 | 60 | 1 | 2814 | ◯ |
| Comp. Ex. 5 | 3 | 170 | 1.0 | 40 | 60 | 1 | 2137 | voids notably generated |
| Comp. Ex. 6 | 5 | 1 | 1.0 | 40 | 60 | 1 | — | Nozzle clogged |
| Example 6 | 5 | 3 | 1.0 | 40 | 60 | 1 | 2823 | ◯ |
| Example 7 | 5 | 5 | 1.0 | 40 | 60 | 1 | 2906 | ◯ |
| Example 8 | 5 | 20 | 1.0 | 40 | 60 | 1 | 2828 | ◯ |
| Example 9 | 5 | 70 | 1.0 | 40 | 60 | 1 | 2759 | ◯ |
| Example 10 | 5 | 150 | 1.0 | 40 | 60 | 1 | 2734 | ◯ |
| Comp. Ex. 7 | 5 | 170 | 1.0 | 40 | 60 | 1 | 2098 | voids notably generated |
| Comp. Ex. 8 | 15 | 1 | 1.0 | 40 | 60 | 1 | — | Nozzle clogged |
| Example 11 | 15 | 3 | 1.0 | 40 | 60 | 1 | 2691 | ◯ |
| Example 12 | 15 | 5 | 1.0 | 40 | 60 | 1 | 2714 | ◯ |
| Example 13 | 15 | 20 | 1.0 | 40 | 60 | 1 | 2740 | ◯ |

TABLE 2

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite | | |
| | compound | Al powder | (intermetallic | material | layer | arm spacing | CV product | |
| | (μm) | (μm) | compound/Al) | (μm) | (μm) | (μm) | (μFV/cm²) | Evaluation |
| Example 14 | 15 | 70 | 1.0 | 40 | 60 | 1 | 2673 | ◯ |
| Example 15 | 15 | 150 | 1.0 | 40 | 60 | 1 | 2658 | ◯ |
| Comp. Ex. 9 | 15 | 170 | 1.0 | 40 | 60 | 1 | 2173 | voids notably generated |
| Comp. Ex. 10 | 50 | 1 | 1.0 | 40 | 60 | 1 | — | Nozzle clogged |
| Example 16 | 50 | 3 | 1.0 | 40 | 60 | 1 | 2776 | ◯ |
| Example 17 | 50 | 5 | 1.0 | 40 | 60 | 1 | 2822 | ◯ |
| Example 18 | 50 | 20 | 1.0 | 40 | 60 | 1 | 2735 | ◯ |
| Example 19 | 50 | 70 | 1.0 | 40 | 60 | 1 | 2682 | ◯ |
| Example 20 | 50 | 150 | 1.0 | 40 | 60 | 1 | 2792 | ◯ |
| Comp. Ex. 11 | 50 | 170 | 1.0 | 40 | 60 | 1 | 2128 | voids notably generated |
| Comp. Ex. 12 | 100 | 1 | 1.0 | 40 | 60 | 1 | — | Nozzle clogged |
| Example 21 | 100 | 3 | 1.0 | 40 | 60 | 1 | 2813 | ◯ |
| Example 22 | 100 | 5 | 1.0 | 40 | 60 | 1 | 2728 | ◯ |
| Example 23 | 100 | 20 | 1.0 | 40 | 60 | 1 | 2659 | ◯ |
| Example 24 | 100 | 70 | 1.0 | 40 | 60 | 1 | 2867 | ◯ |
| Example 25 | 100 | 150 | 1.0 | 40 | 60 | 1 | 2741 | ◯ |
| Comp. Ex. 13 | 100 | 170 | 1.0 | 40 | 60 | 1 | 2119 | voids notably generated |
| Comp. Ex. 14 | 150 | 20 | 1.0 | 40 | 60 | 1 | 2254 | voids notably generated |
| Comp. Ex. 15 | 150 | 70 | 1.0 | 40 | 60 | 1 | 2293 | voids notably generated |
| Comp. Ex. 16 | 150 | 150 | 1.0 | 40 | 60 | 1 | 2170 | voids notably generated |

### EXAMPLE 26

As shown in FIG. 1A, while emitting a plasma flow 4 from a nozzle 3, Al₃Zr powder (intermetallic compound powder) with an average particle diameter of 15 μm was fed from one of material feeding pipes 5 and Al powder 8 with an average particle diameter of 20 μm from the other material feeding pipe 5, so that the plasma flow 4 was thermally sprayed onto both surfaces of a core material 2 made of an aluminum foil with a thickness of 40 μm. Thus, an electrode sheet 10 as shown in FIG. 2 was obtained. The plasma thermal spraying was performed by setting the thermal spraying mass ratio) to Al₃Zr powder/Al powder=1.0. The thickness of the formed thermally sprayed coating layer 11 was 5 μm. Accordingly, an electrode sheet 10 with a thickness of 15 μm was obtained.

The interval (dendrite arm spacing) of the adjacent secondary branches in the dendrite of the intermetallic compound phase in the thermally sprayed coating layer 11 of the obtained electrode sheet was 1 μm on average.

Next, the electrode sheet was immersed in a 3% (mass %)−H₃PO₄ solution and boiled for 120 seconds at 90° C. Thereafter, the sheet was washed with running water and further subjected to ultrasonic cleaning in an acetone solvent, then dried for 5 minutes at 50° C.

Subsequently, etching treatment was performed. This etching treatment was performed using HCl (1 mol/L)+H₂SO₄ (3.5 mol/L) solution under the condition that the temperature of the solution was 75° C. and the current density DC was 0.5 A/cm² (one side).

Furthermore, the electrode sheet was subjected to a constant-voltage chemical conversion treatment of 20V×10 minutes and current density of 5 mA/cm² in an ammonium phosphate solution (concentration: 1.5 g/L, 85° C.).

Subsequently, heat treatment (annealing) was performed for 5 minutes at 500° C. in air, and then a chemical conversion treatment was performed again under the same condition of the previous chemical conversion treatment (except that the constant-voltage chemical conversion treatment time was 5 minutes).

### EXAMPLES 27 TO 50

### COMPARATIVE EXAMPLES 17 TO 32

In each example, an electrode sheet was obtained in the same manner as in Example 26, except that a core material 2 of an Al foil with a thickness shown in Tables 3 and 4 was used and the thickness of the thermally sprayed coating layer 11 was set to a thickness shown in Tables 3 and 4.

TABLE 3

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite arm | CV product | |
| | compound | Al powder | (intermetallic | material | layer | spacing | ratio | |
| | (μm) | (μm) | compound/Al) | (μm) | (μm) | (μm) | (μFV/cm²/μm) | Evaluation |
| Comp. Ex. 17 | 15 | 20 | 1.0 | 3 | 20 | 1 | — | insufficient flexural rigidity |
| Comp. Ex. 18 | 15 | 20 | 1.0 | 3 | 60 | 1 | — | insufficient flexural rigidity |
| Comp. Ex. 19 | 15 | 20 | 1.0 | 3 | 100 | 1 | — | insufficient flexural rigidity |
| Comp. Ex. 20 | 15 | 20 | 1.0 | 5 | 3 | 1 | 19.7 | Law capacity |
| Example 26 | 15 | 20 | 1.0 | 5 | 5 | 1 | 24.5 | ◯ |
| Example 27 | 15 | 20 | 1.0 | 5 | 20 | 1 | 24.5 | ◯ |
| Example 28 | 15 | 20 | 1.0 | 5 | 60 | 1 | 23.4 | ◯ |
| Example 29 | 15 | 20 | 1.0 | 5 | 100 | 1 | 23.0 | ◯ |
| Example 30 | 15 | 20 | 1.0 | 5 | 150 | 1 | 22.7 | ◯ |
| Comp. Ex. 21 | 15 | 20 | 1.0 | 5 | 300 | 1 | 16.7 | Law capacity |
| Comp. Ex. 22 | 15 | 20 | 1.0 | 20 | 3 | 1 | 19.0 | Law capacity |
| Example 31 | 15 | 20 | 1.0 | 20 | 5 | 1 | 22.9 | ◯ |
| Example 32 | 15 | 20 | 1.0 | 20 | 20 | 1 | 23.4 | ◯ |
| Example 33 | 15 | 20 | 1.0 | 20 | 60 | 1 | 23.8 | ◯ |
| Example 34 | 15 | 20 | 1.0 | 20 | 100 | 1 | 23.0 | ◯ |
| Example 35 | 15 | 20 | 1.0 | 20 | 150 | 1 | 22.5 | ◯ |
| Comp. Ex. 23 | 15 | 20 | 1.0 | 20 | 300 | 1 | 16.4 | Law capacity |
| Comp. Ex. 24 | 15 | 20 | 1.0 | 40 | 3 | 1 | 16.4 | Law capacity |
| Example 36 | 15 | 20 | 1.0 | 40 | 5 | 1 | 22.8 | ◯ |
| Example 37 | 15 | 20 | 1.0 | 40 | 20 | 1 | 24.6 | ◯ |

TABLE 4

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite arm | CV product | |
| | compound | Al powder | (intermetallic | material | layer | spacing | ratio | |
| | (μm) | (μm) | compound/Al) | (μm) | (μm) | (μm) | (μFV/cm²/μm) | Evaluation |
| Example 38 | 15 | 20 | 1.0 | 40 | 60 | 1 | 22.1 | ◯ |
| Example 39 | 15 | 20 | 1.0 | 40 | 100 | 1 | 22.9 | ◯ |
| Example 40 | 15 | 20 | 1.0 | 40 | 150 | 1 | 22.2 | ◯ |
| Comp. Ex. 25 | 15 | 20 | 1.0 | 40 | 300 | 1 | 15.7 | Law capacity |
| Comp. Ex. 26 | 15 | 20 | 1.0 | 100 | 3 | 1 | 18.3 | Law capacity |
| Example 41 | 15 | 20 | 1.0 | 100 | 5 | 1 | 23.1 | ◯ |
| Example 42 | 15 | 20 | 1.0 | 100 | 20 | 1 | 24.4 | ◯ |
| Example 43 | 15 | 20 | 1.0 | 100 | 60 | 1 | 22.8 | ◯ |
| Example 44 | 15 | 20 | 1.0 | 100 | 100 | 1 | 23.3 | ◯ |
| Example 45 | 15 | 20 | 1.0 | 100 | 150 | 1 | 21.3 | ◯ |
| Comp. Ex. 27 | 15 | 20 | 1.0 | 100 | 300 | 1 | 15.8 | Law capacity |
| Comp. Ex. 28 | 15 | 20 | 1.0 | 200 | 3 | 1 | 19.8 | Law capacity |
| Example 46 | 15 | 20 | 1.0 | 200 | 5 | 1 | 24.1 | ◯ |
| Example 47 | 15 | 20 | 1.0 | 200 | 20 | 1 | 23.2 | ◯ |
| Example 48 | 15 | 20 | 1.0 | 200 | 60 | 1 | 24.0 | ◯ |
| Example 49 | 15 | 20 | 1.0 | 200 | 100 | 1 | 23.8 | ◯ |
| Example 50 | 15 | 20 | 1.0 | 200 | 150 | 1 | 21.4 | ◯ |
| Comp. Ex. 29 | 15 | 20 | 1.0 | 200 | 300 | 1 | 16.6 | Law capacity |
| Comp. Ex. 30 | 15 | 20 | 1.0 | 300 | 20 | 1 | — | larger curvature at winding |
| Comp. Ex. 31 | 15 | 20 | 1.0 | 300 | 60 | 1 | — | larger curvature at winding |
| Comp. Ex. 32 | 15 | 20 | 1.0 | 300 | 100 | 1 | — | larger curvature at winding |

### EXAMPLE 51

An electrode sheet was obtained in the same manner as in Example 38, except that the thermal spraying mass ratio was set to Al₃Zr powder/Al powder=0.1.

### EXAMPLES 52 TO 55

### COMPARATIVE EXAMPLES 33, 34

In each example, an electrode sheet was obtained in the same manner as in Example 51, except that the thermal spraying mass ratio was set to the value shown in Table 5.

TABLE 5

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite arm | | |
| | compound | Al powder | (intermetallic | material | layer | spacing | CV product | |
| | (μm) | (μm) | compound/Al) | (μm) | (μm) | (μm) | efficiency | Evaluation |
| Comp. Ex. 33 | 15 | 20 | 0.05 | 40 | 60 | 1 | 0.79 | Law capacity |
| Example 51 | 15 | 20 | 0.1 | 40 | 60 | 1 | 0.96 | ◯ |
| Example 52 | 15 | 20 | 0.5 | 40 | 60 | 1 | 0.98 | ◯ |
| Example 53 | 15 | 20 | 1.0 | 40 | 60 | 1 | 1.00 | ◯ |
| Example 54 | 15 | 20 | 2.0 | 40 | 60 | 1 | 0.99 | ◯ |
| Example 55 | 15 | 20 | 5.0 | 40 | 60 | 1 | 0.98 | ◯ |
| Comp. Ex. 34 | 15 | 20 | 10.0 | 40 | 60 | 1 | 0.82 | Law capacity |

### EXAMPLES 56 TO 58

### COMPARATIVE EXAMPLE 35

In each examples an electrode sheet was obtained in the same manner as in Example 1, except that an average particle diameter of Al₃Zr powder was 15 μm, an average particle diameter of Al powder was 20 μm and plasma thermal spraying was performed so that the dendrite arm spacing becomes the value shown in Table 6.

TABLE 6

| | Average | | | | Thickness | | | |
|---|---|---|---|---|---|---|---|---|
| | particle | Average | Thermal | | of | | | |
| | diameter of | particle | spraying mass | Thickness | thermally | | | |
| | intermetallic | diameter of | ratio | of core | sprayed | Dendrite arm | | |
| | compound | Al powder | (intermetallic | material | layer | spacing | CV product | |
| | (μm) | (μm) | compound/Al) | (μm) | (μm) | (μm) | (μFV/cm²) | Evaluation |
| Example 56 | 15 | 20 | 1.0 | 40 | 60 | 0.5 | 2879 | ◯ |
| Example 57 | 15 | 20 | 1.0 | 40 | 60 | 1 | 2753 | ◯ |
| Example 58 | 15 | 20 | 1.0 | 40 | 60 | 5 | 2915 | ◯ |
| Comp. Ex. 35 | 15 | 20 | 1.0 | 40 | 60 | 30 | 2117 | Law capacity |

### EXAMPLE 59

An electrode sheet was obtained in the same manner as in Example 13, except that Al₃Ti powder with an average particle diameter of 15 μm was used as intermetallic compound powder in place of Al₃Ti powder.

### EXAMPLE 60

An electrode sheet was obtained in the same manner as in Example 13, except that Al₃Nb powder with an average particle diameter of 15 μm was used as intermetallic compound powder in place of Al₃Nb powder.

### EXAMPLE 61

An electrode sheet was obtained in the same manner as in Example 13, except that Al₃Ta powder with an average particle diameter of 15 μm was used as intermetallic compound powder in place of Al₃Ta powder.

### EXAMPLE 62

An electrode sheet was obtained in the same manner as in Example 13, except that Al₃Hf powder with an average particle diameter of 15 μm was used as intermetallic compound powder in place of Al₃Hf powder.

TABLE 7

| | | Average | | | | Thickness | | | |
|---|---|---|---|---|---|---|---|---|---|
| | | particle | Average | Thermal | | of | | | |
| | Type of | diameter of | parcel | spraying mass | Thickness | thermally | | | |
| | intermetallic | intermetallic | diameter of | ratio | of core | sprayed | Dendrite arm | | |
| | compound | compound | Al powder | (intermetallic | material | layer | spacing | CV product | |
| | powder | (μm) | (μm) | compound/Al) | (μm) | (μm) | (μm) | (μFV/cm²) | Evaluation |
| Example 59 | Al₃Ti | 15 | 20 | 1.0 | 40 | 60 | 1 | 1988 | ◯ |
| Example 60 | Al₃Nb | 15 | 20 | 1.0 | 40 | 60 | 1 | 2011 | ◯ |
| Example 61 | Al₃Ta | 15 | 20 | 1.0 | 40 | 60 | 1 | 1969 | ◯ |
| Example 62 | Al₃Hf | 15 | 20 | 1.0 | 40 | 60 | 1 | 2053 | ◯ |

The CV product of each electrode sheet obtained as mentioned above was measured, and the various following evaluations were performed. These evaluation results are shown in Tables 1 to 7.

### <Evaluation on Whether Clogging of the Material Feeding Nozzle was Occurred>

In cases where clogging of the nozzle of the material feeding pipe was occurred during the thermal spraying and therefore powder was not thermally sprayed in a stable manner, the evaluation column in Tables was noted as “nozzle clogged.”

<Evaluation on Whether Voids were Generated>

In cases where voids were notably recognized in the thermally sprayed layer from cross-sectional observation of the obtained electrode sheet, the evaluation column in Tables was noted as “voids notably generated.”

### <Evaluation of Bending Characteristic>

In cases where cracks were generated in the electrode sheet when it was wound on an external periphery of a round bar of aluminum with a diameter of 1 mm, the evaluation column in Tables was noted as “insufficient flexural rigidity.” In cases where a gap was formed between the external periphery of the round bar and the electrode sheet when it was wound on the external periphery of the round bar, the evaluation column in Tables was noted as “larger curvature at winding.”

### <Evaluation of Capacitance>

In cases where insufficient capacitance was obtained, the evaluation column in Tables was noted as “low capacitance.” The “CV product ratio” in Tables 3 and 4 is a value obtained by dividing the CV product with the thickness of the thermally sprayed layer. The “CV product efficiency” in Table 5 is a value obtained by dividing respective CV product with the greatest value of the CV product (Example 53).

In cases where sufficient capacitance was obtained, no clogging of a nozzle was occurred, no void was generated in a thermally sprayed layer, and bending characteristic was good, the evaluation in Tables is noted as “∘.”

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

### INDUSTRIAL APPLICABILITY

The electrode sheet for capacitors according to the present invention can be used as an electrode for capacitors for use in communication facilities, such as a personal computer and cellular phones, especially anode material for electrolytic capacitors.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method for manufacturing an electrode sheet for capacitors, the method comprising the step of:
thermally spraying mixed powder in which intermetallic compound powder comprising of Al and valve action metal other than Al and Al powder are mixed, onto a surface of an aluminum foil to thereby form an alloy layer of Al-valve action metal other than Al on at least one surface of the aluminum foil.

2. A method for manufacturing an electrode sheet for capacitors, the method comprising the steps of:
supplying Al powder and intermetallic compound powder comprising of Al and valve action metal other than Al from different positions; and
thermally spraying both powders of the intermetallic compound and the Al onto a surface of an aluminum foil to thereby form an Al-valve action metal alloy layer on at least one surface of the aluminum foil.

3. The method for manufacturing an electrode sheet for capacitors as recited in claim 1 or 2, wherein the thermal splaying is performed by plasma spraying.

4. A method for manufacturing an electrode sheet for capacitors, the method comprising the step of:
supplying Al powder and intermetallic compound powder comprising of Al and valve action metal other than Al from different positions into a single plasma flow; and
thermally spraying the plasma flow onto a surface of an aluminum foil to thereby form an alloy layer of Al-valve action metal other than Al on at least one surface of the aluminum foil.

5. The method for manufacturing an electrode sheet for capacitors as recited in claim 1, 2 or 4, further comprising the step of rolling the electrode sheet after forming an alloy layer of the Al-valve action metal other than Al.

6. The method for manufacturing an electrode sheet for capacitors as recited in claim 1, 2 or 4, further comprising the step of annealing the electrode sheet after forming an alloy layer of the Al-valve action metal other than Al.

7. The method for manufacturing an electrode sheet for capacitors as recited in claim 1, 2 or 4, wherein an average particle diameter of the intermetallic compound powder is 3 to 100 μm, and wherein an average particle diameter of the Al powder is 3 to 150 μm.

8. The method for manufacturing an electrode sheet for capacitors as recited in claim 1, 2 or 4, wherein a thermal spraying mass ratio of the intermetallic compound powder and the Al powder (intermetallic compound powder/Al powder) is set so as to fall within the range of 0.1 to 5.

9. The method for manufacturing an electrode sheet for capacitors as recited in claim 1, 2 or 4, wherein powder of intermetallic compounds comprising of Al and one or more elements selected from the group consisting of Ti, Zr, Nb, Ta and Hf is used as the intermetallic compound powder.

10. The method for manufacturing an electrode sheet for capacitors as recited in claim 1, 2 or 4, wherein Al₃Zr powder is used as the intermetallic compound powder.

11. The method for manufacturing an electrode sheet for capacitors as recited in claim 1, 2 or 4, wherein an alloy foil comprising of Al and valve action metal comprising one or more elements selected from the group consisting of Ti, Zr, Nb, Ta and Hf is used as the aluminum foil.

12. A capacitor electrode sheet manufactured by the method as recited in claims 1, 2 or 4, wherein a fine structure of the Al-valve action metal alloy layer comprises an intermetallic compound phase and an Al simple substance phase, and wherein an interval of adjacent secondary branches in a dendrite (dendrite crystal) of the intermetallic compound phase is 5 μm or less.

13. A capacitor electrode sheet in which an aluminum alloy coating layer is integrally formed on at least one surface of a core material made of aluminum foil,
wherein a fine structure of the coating layer comprises an intermetallic compound phase and an Al simple substance phase.

14. The capacitor electrode sheet as recited in claim 13, wherein an interval of adjacent secondary branches in a dendrite (dendrite crystal) of the intermetallic compound phase is 5 μm or less.

15. The capacitor electrode sheet as recited in claim 13 or 14, wherein a thickness of the core material is 5 to 200 μm, and wherein the thickness of the coating layer is 5 to 150 μm.

16. A method for manufacturing an anode material for electrolytic capacitors, the method comprising the steps of:
etching the electrode sheet manufactured by the method as recited in claim 1, 2 or 4; and then
subjecting the etched electrode sheet to an anodizing treatment to form a dielectric skin on the surface of the electrode sheet.

17. An anode material for electrolytic capacitors manufactured by the method as recited in claim 16.

18. An electrolytic capacitor constituted by using the anode material as recited in claim 17.

19. A method for manufacturing an anode material for electrolytic capacitors, the method comprising the steps of:
etching the electrode sheet as recited in claim 12; and then
subjecting the etched electrode sheet to an anodizing treatment to form a dielectric skin on the surface of the electrode sheet.

20. An anode material for electrolytic capacitors manufactured by the method as recited in claim 19.

21. An electrolytic capacitor constituted by using the anode material as recited in claim 20.

22. A method for manufacturing an anode material for electrolytic capacitors, the method comprising the steps of:
etching the electrode sheet as recited in claim 13 or 14; and then
subjecting the etched electrode sheet to an anodizing treatment to form a dielectric skin on the surface of the electrode sheet.

23. An anode material for electrolytic capacitors manufactured by the method as recited in claim 22.

24. An electrolytic capacitor constituted by using the anode material as recited in claim 23.
